(19) United States
(12) Patent Application Publication
(10) Pub. No.: US 2023/0040048 A1
(43) Pub. Date: Feb. 9, 2023

(54) System For The Simulation Of Electromagnetic Field Propagation

(71) Applicant: THE REGENTS OF THE UNIVERSITY OF MICHIGAN, Ann Arbor, MI (US)

(72) Inventors: Sridhar LAKSHMANAN, Belleville, MI (US); Timothy KLEINOW, Woodhaven, MI (US); Paul WATTA, Grosse Pointe, MI (US)

(73) Assignee: THE REGENTS OF THE UNIVERSITY OF MICHIGAN, Ann Arbor, MI (US)

(21) Appl. No.: 17/875,879

(22) Filed: Jul. 28, 2022

Related U.S. Application Data
(63) Continuation of application No. 63/226,358, filed on Jul. 28, 2021.

(51) Int. Cl. G06F 30/20; G06T 15/06; G06T 7/13

(52) U.S. Cl. CPC G06F 30/20; G06T 15/06; G06T 7/13; G06F 2111/10

(57) ABSTRACT

A method for simulating interactions between a propagating field and occluding bodies in a volume is provided. The method includes using a processor to construct a three-dimensional grid structure having a plurality of cells, the volume containing a plurality of two-dimensional triangles that intersect or reside in one or more of the cells; to iterate through a plurality of rays and trace each ray of the plurality to approximate the propagating field; to determine and account for all interactions between each ray of the plurality and the occluding bodies, where the determining includes performing ray-triangle intersection for all triangles of the plurality of triangles intersecting or residing in cells occupied by the occluding bodies, and the accounting includes adding additional rays of the plurality of rays as reflections, transmissions, and diffractions of the approximated propagating field.

### CROSS-REFERENCE TO RELATED APPLICATIONS

This application claims the benefits of U.S. Provisional Application No. 63/226,258 filed on Jul. 28, 2021, the entire disclosure of which is incorporated herein by reference.

### FIELD

The present disclosure relates to systems and methods for simulating steady state electromagnetic (“EM”) field strength and power in arbitrary environments, including radiating antennas and solid three-dimensional (“3D”) occluding bodies.

### BACKGROUND

Electromagnetic simulation packages are commonly used for previewing potential scenarios prior to empirical testing, to preview test configurations and expectations, as well as justifying and defining field tests. Example conventional electromagnetic simulation packages include AWR Analyst, COMSOL Multiphysics, and Altair's FEKO, and WinProp, each of which provide options for simulating interactions between a propagating field and occluding bodies using techniques such as Finite Element Analysis (“FEA”), Method of Moment (“MoM”), Finite Difference Time Domain (“FDTD”), Empirical Methods (“EM”), Standard Ray Tracing (“SRT”), and/or Dominant Path Model (“DPM”). A common problem, however, is performance. For example, using WinProp's Standard Ray Tracing to simulate a field from a single antenna interacting with several metal boxes in an area of resolution having 300×150 cells can take several hours for a single simulation if ray scatting is enabled, which necessarily limits the number of reflections, refractions, diffractions, and rays that can be considered, causing tradeoffs between expense and accuracy. There is also a problem of re-simulating the same scenarios using different resolutions. Common simulation packages, like the WinProp's Standard Ray Tracing, do not make use of previous calculates. Rather these simulation packages, start anew in each instance.

Yet another common problem, is the proprietary nature of such existing systems, which often results in legacy features and difficulties interacting with established standards. For example, when using WinProp's Standard Ray Tracing program, viewing a simulation in three-dimensional mode requires a special operation that disables most other functionality and shows only a limited version of the setup with difficult, non-standard camera controls. Instead of using industry standard three-dimensional model files, in such instances, the user needs often use the files provide in the proprietary database format, or else a program (e.g., WallMan) separate from the simulator (e.g., PropMan) to build up occludes piece by piece, frequently requiring the user to manually type in the three-dimensional coordinate of model vertices individually for models with non-trivial geometry.

Accordingly, there is a need for systems, and methods of making and using the same, for simulating steady state electromagnetic (“EM”) field strength and power in arbitrary environments that provide modern interfaces, full three-dimensional simulation editor, and an ability to load standard format files.

This section provides background information related to the present disclosure which is not necessarily prior art.

### SUMMARY

This section provides a general summary of the disclosure, and is not a comprehensive disclosure of its full scope or all of its features.

In various aspects, the present disclosure provides a method for simulating interactions between a propagating field and one or more occluding bodies in a volume. The method may include using a processor to construct a three-dimensional grid acceleration structure that includes a plurality of cells, where the volume contains a plurality of two-dimensional triangles that intersect or reside in one or more of the plurality of cells; to iterate through a plurality of rays and trace each of the plurality of rays to approximate the propagating field, where tracing each ray of the plurality of rays includes determining a starting point and stepping through each cell of the plurality of cells through which the ray intersects or travels; to determine and account for all interactions between each ray of the plurality of rays and the one or more occluding bodies, where the determining of all of the interactions between each ray of the plurality of rays and the one or more occluding bodies includes performing ray-triangle intersection for all triangles of the plurality of triangles intersecting or residing in cells occupied by the one or more occluding bodies, and the accounting for all of the interactions between each ray of the plurality of rays and the one or more occluding bodies includes adding additional rays of the plurality of rays as reflections, transmissions, and diffractions of the approximated propagating field.

In one aspect, the constructing of the three-dimensional grid acceleration structure may use a planar step process that includes a box-in-triangle test.

In one aspect, the box-in-triangle test may include using the processor to determine a plane for each triangle, where the plane for each triangle is represented by:

Nₓ(x−Aₓ)+N_{y}(y−A_{y})+N_{z}(z−A_{z})=0

where N is a vector normal to the plane of the respective triangle, A is a point of interest on the plane of the respective triangle, and x, y, and z are the x-, y-, and z-coordinates, respectively, of another point on the plane of the respective triangle, and to rearrange the plane of the respective triangle in terms of dot-products shows that for any point (x, y, z) on the plane of the respective triangle the dot product of that point with the normal vector will be equal to the dot product of any other point on the plane of the respective triangle with its normal vector, and this vector is a constant offset for the respective triangle of the plurality of triangles, represented by:

N·(x,y,z)=N·A.

In one aspect, the box-in-triangle test may further include using the processor to determine for each triangle of the plurality of triangles, a distance between the plane of the respective triangle and a center point of each cell of the plurality of cells, where the distance between the plane of the respective triangle and the center point of the respective cell of the plurality of cells is the difference of the constant offset and a dot product of the center point of the respective cell of the plurality of cells and the normal plane, as represented by:

D=(N·C)−(N·A)

where D is the distance between the plane of the respective triangle and the center point of the respective cell of the plurality of cells, and C is the center point of the respective cell of the plurality of cells.

In one aspect, the box-in-triangle test may further include using the processor to determine a greatest extent of the respective cell of the plurality of cells towards the plane of the respective triangle (Dₘₐₓ), where the greatest extent of the respective cell of the plurality of cells towards the plane of the respective triangle (Dₘₐₓ) is a sum of absolute values of products of like terms, as represented by:

Dₘₐₓ=|NₓBₓ|+|N_{y}B_{y}|+|N_{z}B_{z}|+∈ₜ

where B is a vector from the center point of the respective cell of the plurality of cells to one corner of the volume, and ∈ₜ is a triangle thickness for the respective triangle of the plurality of triangles reducing floating point errors.

In one aspect, the box-in-triangle test may further include using the processor to determine if one or more cells of the plurality of cells intersects the respective triangle of the plurality of triangles, where determining if one or more cells of the plurality of cells intersects the respective triangle of the plurality of triangles includes comparing a value of the greatest extent of the one or more cells of the plurality of cells to the plane of the respective triangle with the distance from the center point of the respective cell of the plurality of cells to the plane of the respective triangle, where an intersection is possible only if the distance from the center point of the respective cell of the plurality of cells to the plane of the respective triangle is less than the greatest extent of the one or more cells of the plurality of cells toward the plane of the respective triangle.

In one aspect, the box-in-triangle test may further include using the processor to determine the distance (D) from each cell of the plurality of cells to each triangle in the plurality of triangles in linear time by separating the x, y, and z components of the calculation of (N·C) required for the calculation of distance (D), as represented by:

D=(NₓCₓ+N_{y}C_{y}+N_{z}C_{z})−(N·A)

where for subsequent cells of the plurality of cells along the x, y, or z axes, the value of NₓCₓ, N_{y}C_{y}, or N_{z}C_{z} respectively is found by adding a constant term to the same value found for the previous cell along the respective axis, the constant term can be represented by NₓSₓ, N_{y}S_{y}, or N_{z}S_{z} respectively for the x, y, and z axes, where Sₓ, S_{y}, and S_{z} are the length of each cell of the plurality of cells along the x, y, and z axes respectively, and where using the processor to precompute each of these values of NₓCₓ, N_{y}C_{y}, and N_{z}C_{z}, the distance (D) from each cell of the plurality of cells to each triangle of the plurality of triangles is computed as the addition of four precomputed values, these being NₓCₓ, N_{y}C_{y}, N_{z}C_{z}, and −(N·A), moving the bulk of processor work into linear time precomputation in place of cubic time.

In one aspect, the box-in-triangle test may further include using the processor to determine edge-normal plane-tangent vectors for each edge of the respective triangle of the plurality of triangles as normalized cross-product of each edge of the respective triangle of the pluralities of triangles with the normal vector of the respective triangle of the pluralities of triangles, such that one or more cells of the plurality of cells that do intersection with the plane of the respective triangle but do not intersect with the respective triangle is excluded

In one aspect, the box-in-triangle test may include using the processor to store unit vectors normal to a plane of each triangle of the plurality of triangles and triangle vertex state for each triangle of the plurality of triangles.

In one aspect, the measuring of the distance between each ray of the plurality of rays and the one or more occluding bodies may include preemptively enlarging all triangles of the plurality of triangles by a constant width, where enlarging the triangles may include using the processor to add to each of the triangle vertices a weighted sum of the two edge vectors that meet to make up that vertex, as represented by:

$${A}^{′} = A + [ \frac{\overline{CA}}{\overline{CA} \cdot {T}_{AB}} + \frac{\overline{BA}}{\overline{BA} \cdot {T}_{CA}} ] m \\ {B}^{′} = B + [ \frac{\overline{CB}}{\overline{CB} \cdot {T}_{AB}} + \frac{\overline{AB}}{\overline{AB} \cdot {T}_{BC}} ] m \\ {C}^{′} = C + [ \frac{\overline{A C}}{\overline{A C} \cdot {T}_{BC}} + \frac{\overline{BC}}{\overline{BC} \cdot {T}_{CA}} ] m$$

where A′, B′, and C′ are the locations of the vertices of the respective enlarged triangle, T_{AB}, T_{CA}, and T_{BC} are the edge-normal plane-tangent vectors for each edge AB, CA, and BC between vertices A, B, and C of the respective enlarged triangle, and m is the margin width.

In one aspect, the margin width (m) may be represented by:

$$m = \frac{c}{4 π f tan ( ε \frac{π}{2} )}$$

where f is the frequency of electromagnetic radiation being simulated, and ε is the user's desired minimum diffraction-angle-standard-deviation for consideration.

In one aspect, the measuring of the distance between the ray and the one or more occluding bodies may further include using the processor to determine a distance from an edge of the original triangle without additional margins using the barycentric coordinates as follows:

$${D}_{edgeBC} = m - U \overline{{A}^{′} {B}^{′}} \cdot {T}_{BC} \\ {D}_{edgeAC} = m - V \overline{{B}^{′} {A}^{′}} \cdot {T}_{A C} \\ {D}_{edgeAB} = m - W \overline{{A}^{′} {C}^{′}} \cdot {T}_{AB} ,$$

where, if any of the distances (D_{edgeBC}, D_{edgeAC}, D_{edgeAB}) is positive, the ray hits only the margin and not the actual triangle indicating diffraction, and if each of the distances (D_{edgeBC}, D_{edgeAC}, D_{edgeAB}) is less than zero, the ray hits the actual triangle, and the distances (D_{edgeBC}, D_{edgeAC}, D_{edgeAB}) are used to calculate the deflection angle standard deviation as it corresponds to a physical distance absolutely.

In one aspect, the accounting for all of the interactions between each ray of the plurality of rays and the one or more occluding bodies includes using the processor to determine an angle of diffraction to send another ray of the plurality of rays after a diffraction interaction through the use of Heisenberg's Uncertainty Principle, represented by:

ΔxΔp≥ [symbol] /2

where Δx is the uncertainty in a particle's position, Δp is the uncertainty in the particle's momentum, and [symbol] is the reduced Planck constant, and where the ray is representative of an imagined photon, and an uncertainty in position of the imagined photo is no more than a distance (x) at which the respective ray of the plurality of rays passes from the respective triangle of the plurality of triangles when the respective ray of the plurality of rays hits the margin, such that the Heisenberg's Uncertainty Principle can be restated as:

Δp= [symbol] /(2x)

in the direction from the respective ray of a plurality of rays towards the respective triangle of the plurality of triangles.

In one aspect, at least one ray of the plurality of rays may have a frequency less than about 400 THz.

In one aspect, the processor may be configured to store information and receive and integrate supplemental parameters and data, where integrating an amount of time each ray spends in each cell of the plurality of cells allows an electromagnetic field intensity at each point in the simulation to be developed.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an example of an identified triangle on a regular grid to be used for the selection of data sets for the modified Monte Carlo Ray Tracing (“MCRT”) in accordance with various aspects of the present disclosure;

FIG. 2 is an example enlarged triangle for use in a diffraction margin method in accordance with various aspects of the present disclosure;

FIG. 3A is an example scenario constructed to test the modified Monte Carlo Ray Tracing (“MCRT”) as prepared in accordance with various aspects of the present disclosure; and

FIGS. 3B and 3C illustrate certain results of the scenario constructed in FIG. 3A.

Corresponding reference numerals indicate corresponding parts throughout the several views of the drawings.

### DETAILED DESCRIPTION

Example embodiments will now be described more fully with reference to the accompanying drawing.

A Monte Carlo Ray Tracing (“MCRT”) process, also known as Stochastic Ray Tracing process, is proposed as an alternative to existing wave-equations (e.g., Finite Element Analysis (“FEA”), Method of Moment (“MoM”), Finite Difference Time Domain (“FDTD”)) or analytical ray evaluating algorithms (e.g., Empirical Methods (“EM”), Standard Ray Tracing (“SRT”), and/or Dominant Path Model (“DPM”)) for simulating or previewing interactions between a propagating field and one or more occluding bodies in a volume or defined space. In particular, the proposed process may be used for sub-optical frequencies, which are typically excluded because of diffraction.

The term diffraction is often used to describe the behavior of a wave as it encounters an obstacle on the same scale as its wavelength. In such instances, the wave will be partially incident on the obstacle and either reflected or transmitted and at least partially unimpeded as it flows, or moves past, the obstacle. The wave that moves past the obstacle will spread out after passing the obstacle, resulting in a soft conical shadow that trails off from the obstacle, as explained by the Huygens-Fresnel Principle. In particular, wavelets will continue in all directions, including behind the obstacle and past it, resulting in the appearance of the wave bending around the obstacle. Because the wavelets are evenly distributed over the surface of the preceding wavefront, the waves often cancel out in all but the forward direction because a distance between the waves implies a phase difference that will cause points to separate by a half wavelength to destructively interface. As such, diffractive may be understood as coming primarily from parts of the wavefront that just narrowly miss the obstacle, relative to the wavelength of light. At optical frequencies, the wavelength is short (e.g., less than about 800 nm) and, as such, the effect of diffraction may be completely negligible for large scale simulations. This is not the case, however, at radio frequencies. Traditional stochastic ray tracing approaches are unable to simulate diffraction because the rays are only tested if, or when, they hit the obstacle and cannot take into account how close the rays pass to the obstacle when the rays miss the obstacle.

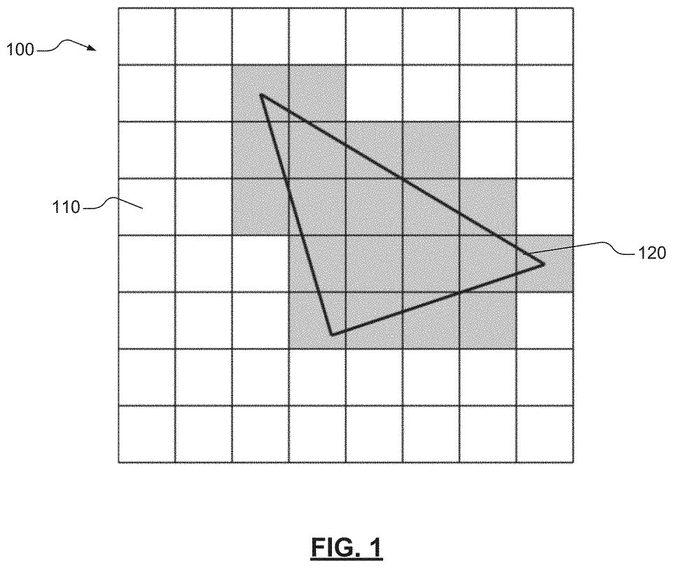

Generally, Monte Carlo Ray Tracing (“MCRT”) is an algorithm for approximating a solution to the light transport integral equation, for example by approximating a continuous radiative field using a finite number of rays from a source, which recursively reflect off of and refract through physically based materials using optical laws and probability distributions. In typical implementations, the goal is to determine the color and intensity of light incident on a virtual camera lens or eye, which is displayed to a user as a single image on a screen. This goal can be accomplished by averaging the individual contributions per pixel using Monte Carlo Integration, which uses the Law of Large Numbers and the definition of integration as an infinite sum of infinitesimal quantities to approximate the solution to the light transport integral. In the present instance, the goal is not to simulate a camera's view of the electromagnetic field, but instead the electromagnetic field itself. To accomplish such, the volume or defined space needs to be divided into a regular grid using grid cells or voxels as sampling bins. Building the regular grid includes, for example, as illustrated in FIG. 1 identifying triangles 120 that intersects or falls within each cell or voxel 110 in the grid 100. Using the proposed modified Monte Carlo Ray Tracing (“MCRT”), the received radio frequency (“RF”) power at every cell in a volume is simulated. The modified Monte Carlo Ray Tracing (“MCRT”) according to the present disclosure uses an efficient uniform grid construction strategy for accelerating ray tracing, and also, includes diffraction margins around the edges of one or more occluders, allowing for realistic diffraction effects within a stochastic ray tracer.

Efficient Uniform Grid Construction Strategy for Accelerating Ray Tracing

The present method includes, using a processor, constructing a three-dimensional grid that comprises a plurality of cells in a volume including one or more occluding bodies, where a plurality of two-dimensional triangles intersects or reside in one or more of the plurality of cells. The three-dimensional grid is often constructed using an acceleration structure to minimize use of the ray-triangle intersection formula by preemptively rejecting triangles that cannot possible be hit by propagating rays. Of course, when grids have smaller cells, it is more probable that the propagating rays will hit a triangle that intersects the cells. The user can design the grid, with appropriate cell sizes, to accomplish the desired resolution.

The method may include applying a box-in-triangle triangle intersection test to every cell within a bounding-volume around each triangle. The box-in triangle test comprises, using a processor, to determine a plane for each triangle (e.g., Planar Step Method). For example, the plane for each triangle may be represented by:

Nₓ(x−Aₓ)+N_{y}(y−A_{y})+N_{z}(z−A_{z})=0

where N is a vector normal to the plane of the respective triangle, A is a point of interest on the plane of the respective triangle, and x, y, and z are the x-, y-, and z-coordinates, respectively, of another point on the plane of the respective triangle. Rearranging the plane of the respective triangle in terms of dot-products shows that for any point (x, y, z) on the plane of the respective triangle the dot product of that point with the normal vector will be equal to the dot product of any other point on the plane of the respective triangle with its normal vector, and this vector is a constant offset for the respective triangle of the plurality of triangles, represented by:

N·(x,y,z)=N·A.

Importantly, the processor can be configured to store unit vector normal to the plane of each triangle with the triangle vertex data. It is often more efficient that such information is frontloaded rather than to deferred until the values are needed during ray collision.

The box-in triangle test further comprises, using a processor, to determine, for each triangle of the plurality of triangles, a distance between the plane of the respective triangle and a center point of each cell of the plurality of cells. The distance between the plane of the respective triangle and the center point of the respective cell of the plurality of cells is the difference of the constant offset and a dot product of the center point of the respective cell of the plurality of cells and the normal plane, as represented by:

D=(N·C)−(N·A)

where D is the distance between the plane of the respective triangle and the center point of the respective cell of the plurality of cells and C is the center point of the respective cell of the plurality of cells.

The box-in triangle test further comprises, using a processor, to determine a greatest extent of the respective cell of the plurality of cells towards the plane of the respective triangle (Dₘₐₓ). The greatest extent of the respective cell of the plurality of cells towards the plane of the respective triangle (Dₘₐₓ) is a sum of absolute values of products of like terms, as represented by:

Dₘₐₓ=|NₓBₓ|+|N_{y}B_{y}|+|N_{z}B_{z}|+∈ₜ

where B is a vector from the center point of the respective cell of the plurality of cells to one corner of the volume, and ∈ₜ is a triangle thickness for the respective triangle of the plurality of triangles reducing floating point errors.

The box-in triangle test further comprises, using a processor, to determine if one or more cells of the plurality of cells intersects the respective triangle of the plurality of triangles. Determining if one or more cells of the plurality of cells intersects the respective triangle of the plurality of triangles comprises comparing a value of the greatest extent of the one or more cells of the plurality of cells to the plane of the respective triangle with the distance from the center point of the respective cell of the plurality of cells to the plane of the respective triangle. An intersection is possible only if the distance from the center point of the respective cell of the plurality of cells to the plane of the respective triangle is less than the greatest extent of the one or more cells of the plurality of cells toward the plane of the respective triangle.

The distance (D) from each cell of the plurality of cells to each triangle in the plurality of triangles (e.g., cell-plan distance) can be determined in linear time instead of looping over cells. For example, the processor may be configured to determine the distance (D) from each cell of the plurality of cells to each triangle in the plurality of triangle in linear time by separating the x, y, and z components of the calculation of (N·C) required for the calculation of distance (D), as represented by:

D=(NₓCₓ+N_{y}C_{y}+N_{z}C_{z})−(N·A)

where (N·A) is a constant (i.e., the plane offset) that can be computed once and stored, by the processor, with the rest of the triangle data, and the x, y, and z components are independent. This determination may be further optimized by noting that the grid has a regular, repeatable pattern, for example, as represented by:

S=Cₐ₊₁−Cₐ

where the distance between subsequent box centers (S) along axis a for a=x, a=y, and a=z is a constant. This quantity is width of a box along the respective axis as represented by:

D=Dₓ+D_{y}+D_{z}+(N·A)

Dₐ=NₐCₐ

Dₐ₊₁=NₐCₐ₊₁=Nₐ(Cₐ+S)=NₐCₐ+NₐS

That is, the value of NₓCₓ, N_{y}C_{y}, or N_{z}C_{z} respectively are found by adding a constant term to the same value found for the previous cell along the respective axis. The constant term can be represented by NₓSₓ, N_{y}S_{y}, or N_{z}S_{z} respectively for the x, y, and z axes, where Sₓ, S_{y}, and S_{z} are the length of each cell of the plurality of cells along the x, y, and z axes respectively. The processor is configured to precompute each of these values of NₓCₓ, N_{y}C_{y}, and N_{z}C_{z}. The distance (D) from each cell of the plurality of cells to each triangle of the plurality of triangles is computed as the addition of four precomputed values, these being NₓCₓ, N_{y}C_{y}, N_{z}C_{z}, and −(N·A), moving the bulk of processor work into linear time precomputation in place of cubic time. That is, allowing the distance of every cell, for example, in a 1000×1000×1000 grid using 3000 operations instead of 1 billion operations.

In sum, the method still further includes performing cubic time iteration over all cells in the bounds of the respective triangle of the plurality of triangles to compute the final distance. That is, while the algorithm still speaks O(N³), the cubic portion includes only a single addition and one or two comparisons to check if the absolute value of the distance is close enough for the cell to hit the plane. The majority of the algorithm can be moved into constant or linear time.

The box-in triangle test further comprises, using a processor, to determine edge-normal plane-tangent vectors for each edge of the respective triangle of the plurality of triangles as normalized cross-product of each edge of the respective triangle of the pluralities of triangles with the normal vector of the respective triangle of the pluralities of triangles, such that one or more cells of the plurality of cells that do intersection with the plane of the respective triangle but do not intersect with the respective triangle are excluded. In other words, by adding calculations for the components of distances from the cell centers to planes defined by the vectors, in addition to the triangle plane, the test can be further refined to exclude those voxels that do line on the plane of the triangle, but that are on a wrong side of the one of the half-spaces that define the respective triangle's edges.

Diffraction Margins Around the Edges of the One or More Occluders

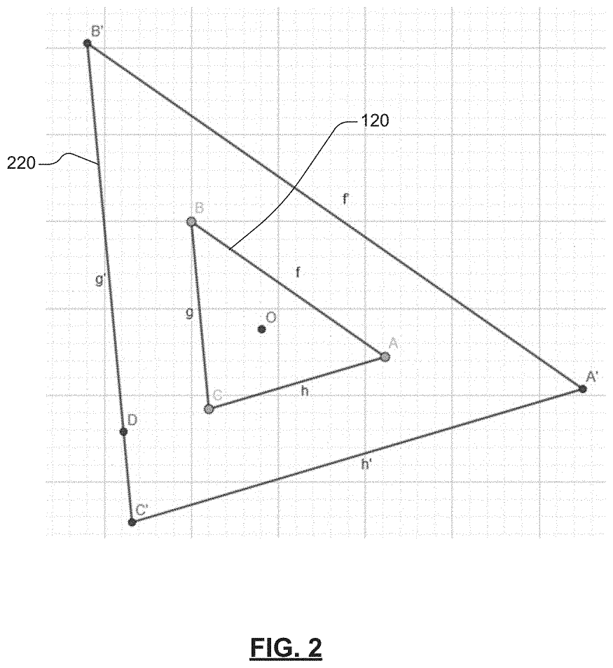

A method for determining how to bend diffracted rays is provided. For example, an accurate measure of the distance from a ray to an occluder that the ray passes but does not hit is provided. Diffraction margins are used to ensure that any ray that would be noticeably diffracted actually does hit a part of the occluder. The diffraction margin method includes preemptively enlarging all triangles of the plurality of triangles by a constant width. For example, FIG. 2 illustrates the example triangle 120 and an example expanded triangle 220. Enlarging the triangles may include adding to each of the triangle vertices a weighted sum of the two edge vectors that meet to make up that vertex, as represented by:

$${A}^{′} = A + [ \frac{\overline{CA}}{\overline{CA} \cdot {T}_{AB}} + \frac{\overline{BA}}{\overline{BA} \cdot {T}_{CA}} ] m \\ {B}^{′} = B + [ \frac{\overline{CB}}{\overline{CB} \cdot {T}_{AB}} + \frac{\overline{AB}}{\overline{AB} \cdot {T}_{BC}} ] m \\ {C}^{′} = C + [ \frac{\overline{A C}}{\overline{A C} \cdot {T}_{BC}} + \frac{\overline{BC}}{\overline{BC} \cdot {T}_{CA}} ] m$$

where A′, B′, and C′ are the locations of the vertices of the respective enlarged triangle, T_{AB}, T_{CA}, and T_{BC} are the edge-normal plane-tangent vectors for each edge AB, CA, and BC between vertices A, B, and C of the respective enlarged triangle, and m is the margin width. As illustrated, the added weight is inversely proportional to the projection of the respective edge vector onto the other edge's normal, multiplied by the diffraction margin width (m), which is an arbitrary quantity that can be derived in terms of frequency of the radiation and the desired diffraction-angle-standard deviation, as represented by:

$$θ = a tan ( \frac{Δ p}{\vert {p}_{old} \vert} ) = a tan ( \frac{\frac{ℏ}{2 x}}{ℏ k} ) = a tan ( \frac{c}{4 π fx} )$$

Setting x=m and θ=ε, the deflection angel at the edge of the margin can be represented by:

$$ε = a tan ( \frac{c}{4 π fm} )$$

Solving for margin (m) the margin width (m) is represented by:

$$m = \frac{c}{4 π f tan ( ε \frac{π}{2} )}$$

where f is the frequency of electromagnetic radiation being simulated and ε is the user's desired minimum diffraction-angle-standard-deviation for consideration. Setting a value of epsilon to 0.001 produces margins that do not show artifacts. Higher values may be appropriate for speeding up simulations where small errors are inconsequential.

The diffraction margin method includes determining a distance between the ray and the one or more occluding bodies. Determining the distance between the ray and the one or more occluding bodies includes calculating a distance from an edge of the original triangle without additional margins using barycentric coordinates. That is, the barycentric coordinates give a measure of a normalized distance from each edge of the triangle, as follows:

$${D}_{edgeBC} = m - U \overline{{A}^{′} {B}^{′}} \cdot {T}_{BC} \\ {D}_{edgeAC} = m - V \overline{{B}^{′} {A}^{′}} \cdot {T}_{A C} \\ {D}_{edgeAB} = m - W \overline{{A}^{′} {C}^{′}} \cdot {T}_{AB}$$

where if any of the distances (D_{edgeBC}, D_{edgeAC}, D_{edgeAB}) is positive, the ray hits only the margin and not the actual triangle indicating diffraction; if each of the distances (D_{edgeBC}, D_{edgeAC}, D_{edgeAB}) is less than zero, the ray hits the actual triangle; and if a coordinate is zero, then the point lies on an edge. In each instance, the distances (D_{edgeBC}, D_{edgeAC}, D_{edgeAB}) are used to calculate the deflection angle standard deviation as it corresponds to a physical distance absolutely.

All interactions between each of the plurality of rays and the one or more occluding bodies need be accounted. Accounting for all interactions includes determining an angle of diffraction to send another ray of the plurality of rays after a diffraction interaction through the use of Heisenberg's Uncertainty Principle, which is represented by:

ΔxΔp≥ [symbol] /2

where Δx is the uncertainty in a particle's position, Δp is the uncertainty in the particle's momentum, [symbol] is the reduced Planck constant. The ray is representative of an imagined photon, and an uncertainty in position of the imagined photo is no more than a distance (x) at which the respective ray of the plurality of rays passes from the respective triangle of the plurality of triangles when the respective ray of the plurality of rays hits the margin, such that the Heisenberg's Uncertainty Principle can be restated as:

Δp= [symbol] /(2x)

in the direction from the respective ray of a plurality of rays towards the respective triangle of the plurality of triangles.

Certain features of the current technology are further illustrated in the following non-limiting examples.

### Example 1

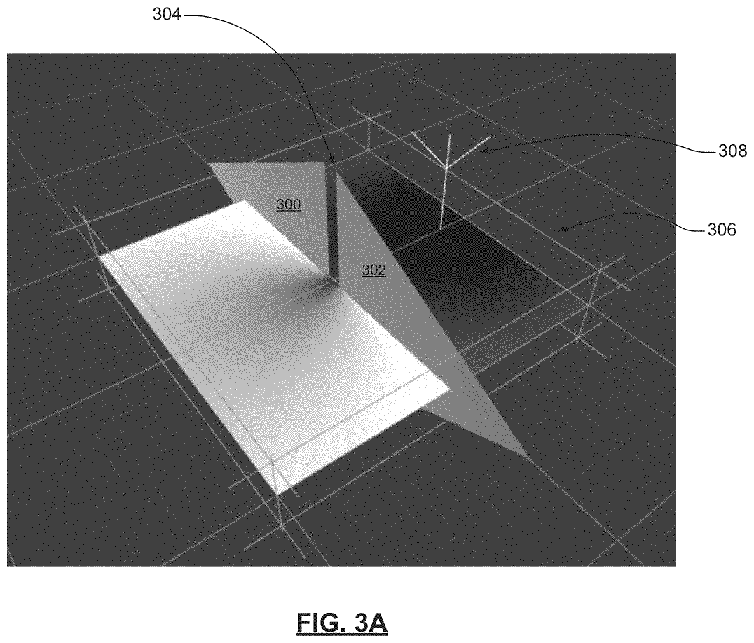

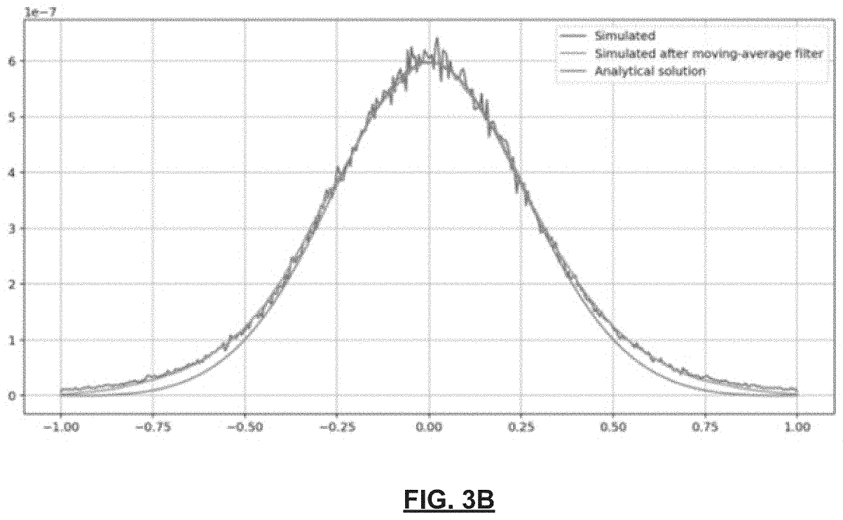

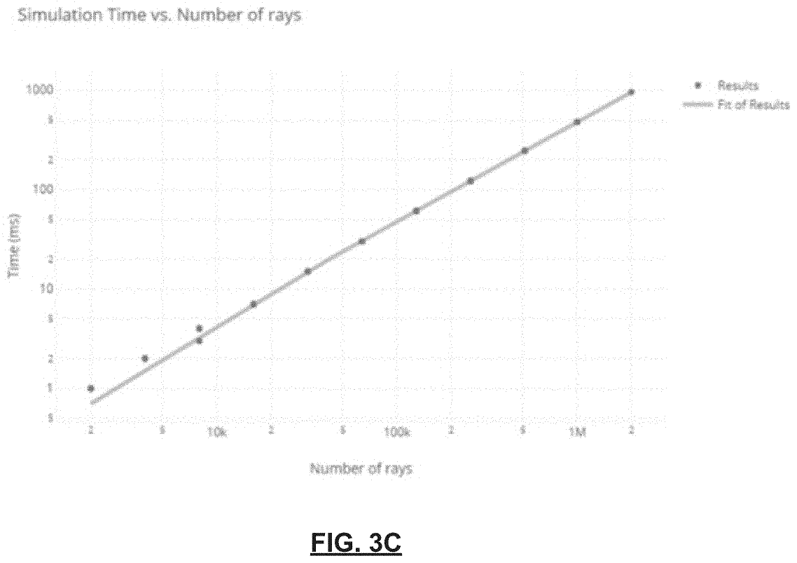

As illustrated in FIG. 3A, a scenario with two occluding triangles 300, 302 with a defined gap 304 therebetween is constructed in a simulated volume 306 to test the ray tracer prepared in accordance with various aspects of the present disclosure. An isotropic point source antenna 308 is disposed in the simulated volume 306. A simulation frequency was set to 5.9 GHz, and the antenna powder was set to 1 W. The simulated volume 306 has dimensions of about 2 meters by 1 meter by 2 meters, and the gap a width of about 75 millimeters. The coloration 310 (shown in gray-scale here) is based on an intensity by mapping a user-defined range to the range of integers from 0 to 360 linearly and using this as the line angle for an HSV color with full saturation and value, where the lower bound was set to −90 dB and the upper bound was set to 10 dB. Using the Huygen's-Fresenl Principle, an analytical solution to the diffraction past a single slit can be derived as

$$I ( θ ) = {I}_{0} I ( 0 ) sin {c}^{2} ( β ) \\ β = k \frac{D}{2} sin ( θ )$$

where I is the intensity (power) a function of the angle theta from the gap 304, I₀ is the initial power, I(I) is the direct undeflected power, k is wavenumber, and D is the width D the gap. The intensity values alone the bottom row of the simulation results can be plot, as illustrated in FIG. 3B, with a moving-average filter version to eliminate some at least a portion of the noise and also an analytical equation for comparison. As seen in the plot, the simulation compares with the expected results.

Performance of the ray tracers can be considered by identifying a number (for example sixteen) uniformly separated triangles of difference sizes in inner and outer rings around the antenna 308. The number of rays traced was increased by powers of two and each trial was ran ten times to reduce the likelihood of undetected statistical anomalies. The results are illustrated in FIG. 3C, where the x-axis is the number of rays, and the y-axis is time in milliseconds. As illustrated, the time is linear in number of rays and the ray tracing algorithm is capable of running over two million rays per second, which is about 500 nanoseconds per ray.

The techniques described herein or portions thereof may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware, or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for simulating interactions between a propagating field and one or more occluding bodies in a volume, wherein the method comprises:
using a processor, constructing a three-dimensional grid acceleration structure that comprises a plurality of cells, the volume containing a plurality of two-dimensional triangles that intersect or reside in one or more of the plurality of cells;
using the processor, iterating through a plurality of rays and tracing each of the plurality of rays to approximate the propagating field, wherein the tracing of each of the plurality of rays comprises determining a starting point and stepping through each cell of the plurality of cells through which the ray intersects or travels;
using the processor, determining and accounting for all interactions between each ray of the plurality of rays and the one or more occluding bodies, the determining all of the interactions between each ray of the plurality of rays and the one or more occluding bodies comprising:
performing ray-triangle intersection for all triangles of the plurality of triangles intersecting or residing in cells occupied by the one or more occluding bodies, and
measuring distances between each ray of the plurality of rays and the one or more occluding bodies, and
the accounting all of the interactions between each ray of the plurality of rays and the one or more occluding bodies comprising:
adding additional rays of the plurality of rays as reflections,
transmissions, and diffractions of the approximated propagating field.

2. The method of claim 1, wherein the constructing of the three-dimensional grid acceleration structure uses a planar step process comprising a box-in-triangle test.

3. The method of claim 2, wherein the box-in-triangle test comprises:
using the processor, determining a plane for each triangle, wherein the plane for each triangle is represented by:
Nₓ(x−Aₓ)+N_{y}(y−A_{y})+N_{z}(z−A_{z})=0
where N is a vector normal to the plane of the respective triangle, A is a point of interest on the plane of the respective triangle, and x, y, and z are the x-, y-, and z-coordinates, respectively, of another point on the plane of the respective triangle, and
wherein rearranging the plane of the respective triangle in terms of dot-products shows that for any point (x, y, z) on the plane of the respective triangle the dot product of that point with the normal vector will be equal to the dot product of any other point on the plane of the respective triangle with its normal vector, and this vector is a constant offset for the respective triangle of the plurality of triangles, represented by:
N·(x,y,z)=N·A.

4. The method of claim 3, wherein the box-in-triangle test further comprises:
using the processor, determining, for each triangle of the plurality of triangles, a distance between the plane of the respective triangle and a center point of each cell of the plurality of cells, wherein the distance between the plane of the respective triangle and the center point of the respective cell of the plurality of cells is the difference of the constant offset and a dot product of the center point of the respective cell of the plurality of cells and the normal plane, as represented by:
D=(N·C)−(N·A)
where D is the distance between the plane of the respective triangle and the center point of the respective cell of the plurality of cells, and C is the center point of the respective cell of the plurality of cells.

5. The method of claim 4, wherein the box-in-triangle test further comprises:
using the processor, determining a greatest extent of the respective cell of the plurality of cells towards the plane of the respective triangle (Dₘₐₓ), wherein the greatest extent of the respective cell of the plurality of cells towards the plane of the respective triangle (Dₘₐₓ) is a sum of absolute values of products of like terms, as represented by:
Dₘₐₓ=|NₓBₓ|+|N_{y}B_{y}|+|N_{z}B_{z}|+∈ₜ
where B is a vector from the center point of the respective cell of the plurality of cells to one corner of the volume, and ∈ₜ is a triangle thickness for the respective triangle of the plurality of triangles reducing floating point errors.

6. The method of claim 5, wherein the box-in-triangle test further comprises:
using the processor, determining if one or more cells of the plurality of cells intersects the respective triangle of the plurality of triangles, wherein determining if one or more cells of the plurality of cells intersects the respective triangle of the plurality of triangles comprises comparing a value of the greatest extent of the one or more cells of the plurality of cells to the plane of the respective triangle with the distance from the center point of the respective cell of the plurality of cells to the plane of the respective triangle, wherein an intersection is possible only if the distance from the center point of the respective cell of the plurality of cells to the plane of the respective triangle is less than the greatest extent of the one or more cells of the plurality of cells toward the plane of the respective triangle.

7. The method of claim 6, wherein the box-in-triangle test further comprises:
using the processor, determining the distance (D) from each cell of the plurality of cells to each triangle in the plurality of triangles in linear time by separating the x, y, and z components of the calculation of (N·C) required for the calculation of distance (D), as represented by:
D=(NₓCₓ+N_{y}C_{y}+N_{z}C_{z})−(N·A)
wherein for subsequent cells of the plurality of cells along the x, y, or z axes, the value of NₓCₓ, N_{y}C_{y}, or N_{z}C_{z} respectively is found by adding a constant term to the same value found for the previous cell along the respective axis,
wherein the constant term can be represented by NₓSₓ, N_{y}S_{y}, or N_{z}S_{z} respectively for the x, y, and z axes, where Sₓ, S_{y}, and S_{z} are the length of each cell of the plurality of cells along the x, y, and z axes respectively, and
wherein using the processor to precompute each of these values of NₓCₓ, N_{y}C_{y}, and N_{z}C_{z}, the distance (D) from each cell of the plurality of cells to each triangle of the plurality of triangles is computed as the addition of four precomputed values, these being NₓCₓ, N_{y}C_{y}, N_{z}C_{z}, and −(N·A), moving the bulk of processor work into linear time precomputation in place of cubic time.

8. The method of claim 6, wherein the box-in-triangle test further comprises:
using the processor, determining edge-normal plane-tangent vectors for each edge of the respective triangle of the plurality of triangles as normalized cross-product of each edge of the respective triangle of the pluralities of triangles with the normal vector of the respective triangle of the pluralities of triangles, such that one or more cells of the plurality of cells that do intersection with the plane of the respective triangle but do not intersect with the respective triangle is excluded

9. The method of claim 2, wherein the box-in-triangle test comprises:
using the processor, storing unit vectors normal to a plane of each triangle of the plurality of triangles and triangle vertex state for each triangle of the plurality of triangles.

10. The method of claim 1, wherein the measuring of the distance between each ray of the plurality of rays and the one or more occluding bodies comprises:
preemptively enlarging all triangles of the plurality of triangles by a constant width, wherein enlarging the triangles comprises:
using the processor, adding to each of the triangle vertices a weighted sum of the two edge vectors that meet to make up that vertex, as represented by:
$${A}^{′} = A + [ \frac{\overline{CA}}{\overline{CA} \cdot {T}_{AB}} + \frac{\overline{BA}}{\overline{BA} \cdot {T}_{CA}} ] m \\ {B}^{′} = B + [ \frac{\overline{CB}}{\overline{CB} \cdot {T}_{AB}} + \frac{\overline{AB}}{\overline{AB} \cdot {T}_{BC}} ] m \\ {C}^{′} = C + [ \frac{\overline{A C}}{\overline{A C} \cdot {T}_{BC}} + \frac{\overline{BC}}{\overline{BC} \cdot {T}_{CA}} ] m$$
where A′, B′, and C′ are the locations of the vertices of the respective enlarged triangle, T_{AB}, T_{CA}, and T_{BC} are the edge-normal plane-tangent vectors for each edge AB, CA, and BC between vertices A, B, and C of the respective enlarged triangle, and m is the margin width.

11. The method of claim 10, wherein the margin width (m) is represented by:
$$m = \frac{c}{4 π f tan ( ε \frac{π}{2} )}$$
where f is the frequency of electromagnetic radiation being simulated, and ε is the user's desired minimum diffraction-angle-standard-deviation for consideration.

12. The method of claim 10, wherein the measuring of the distance between the ray and the one or more occluding bodies further comprises:
using the processor, determining a distance from an edge of the original triangle without additional margins using the barycentric coordinates as follows:
$${D}_{edgeBC} = m - U \overline{{A}^{′} {B}^{′}} \cdot {T}_{BC} \\ {D}_{edgeAC} = m - V \overline{{B}^{′} {A}^{′}} \cdot {T}_{A C} \\ {D}_{edgeAB} = m - W \overline{{A}^{′} {C}^{′}} \cdot {T}_{AB} ,$$
wherein if any of the distances (D_{edgeBC}, D_{edgeAC}, D_{edgeAB}) is positive, the ray hits only the margin and not the actual triangle indicating diffraction, and if each of the distances (D_{edgeBC}, D_{edgeAC}, D_{edgeAB}) is less than zero, the ray hits the actual triangle, and
wherein the distances (D_{edgeBC}, D_{edgeAC}, D_{edgeAB}) are used to calculate the deflection angle standard deviation as it corresponds to a physical distance absolutely.

13. The method of claim 1, wherein the accounting for all of the interactions between each ray of the plurality of rays and the one or more occluding bodies comprises:
using the processor, determining an angle of diffraction to send another ray of the plurality of rays after a diffraction interaction through the use of Heisenberg's Uncertainty Principle, represented by:
ΔxΔp≥ [symbol] /2
where Δx is the uncertainty in a particle's position, Δp is the uncertainty in the particle's momentum, and [symbol] is the reduced Planck constant,
wherein the ray is representative of an imagined photon, and an uncertainty in position of the imagined photo is no more than a distance (x) at which the respective ray of the plurality of rays passes from the respective triangle of the plurality of triangles when the respective ray of the plurality of rays hits the margin, such that the Heisenberg's Uncertainty Principle can be restated as:
Δp= [symbol] /(2x)
in the direction from the respective ray of a plurality of rays towards the respective triangle of the plurality of triangles.

15. The method of claim 1, wherein at least one ray of the plurality of rays has a frequency less than about 400 THz.

16. The method of claim 1, wherein the processor is configured to store information and receive and integrate supplemental parameters and data, where integrating an amount of time each ray spends in each cell of the plurality of cells allows an electromagnetic field intensity at each point in the simulation to be developed.
